(19) United States
(12) Patent Application Publication
(10) Pub. No.: US 2015/0061441 A1
(43) Pub. Date: Mar. 5, 2015

(54) ELECTRIC MACHINE AND ASSOCIATED METHOD

(71) Applicant: Regal Beloit America, Inc., Beloit, WI (US)

(72) Inventors: Daniel Shawn Figgins, Fort Wayne, IN (US); Harold Clifton Kingrey, Blue Ridge, GA (US); Michael Allen Marks, Fort Wayne, IN (US); Jeffrey Alan Hall, Fort Wayne, IN (US); Subhash Marutirao Brahmavar, Fort Wayne, IN (US); Alan Jacob Manz, Paulding, OH (US); David Allen Clendenen, Fort Wayne, IN (US); Rafal Pawel Rohoza, Fort Wayne, IN (US)

(21) Appl. No.: 14/464,949

(22) Filed: Aug. 21, 2014

Related U.S. Application Data
(60) Provisional application No. 61/871,518, filed on Aug. 29, 2013.

(51) Int. Cl. H02K 1/27; H02K 15/02; H02K 21/00

(52) U.S. Cl. CPC H02K 1/2706; H02K 21/00; H02K 15/02
USPC 310/156.01; 310/156.08; 29/598

(57) ABSTRACT

An electric machine includes a machine housing and a stator disposed at least partially within the housing. The electric machine also includes a radially embedded permanent magnet rotor disposed at least partially within the housing and an endcap. The rotor has at least one radially embedded permanent magnet that is configured to provide increased flux to reduce motor efficiency loss. The endcap is operably connected to a distal portion of the rotor.

### CROSS REFERENCE TO RELATED APPLICATION

This application is a non-provisional application and claims priority to U.S. Provisional Patent Application 61/871,518 filed Aug. 29, 2013 for “ELECTRIC MACHINE AND ASSOCIATED METHOD”, which is hereby incorporated by reference in its entirety.

### BACKGROUND OF THE INVENTION

The embodiments described herein relate generally to an electric machine, and more specifically, to a kit and method associated with motors having radially embedded permanent magnet rotors.

Various types of electric machines include permanent magnets. For example, a brushless direct current (BLDC) motor may include a plurality of permanent magnets coupled to an exterior surface of a rotor core. Typically, the permanent magnets are coupled to the exterior surface of the rotor core using an adhesive and/or an outer retaining covering. This coupling between the permanent magnets and the rotor core must resist forces exerted on the permanent magnets during high speed rotation tending to separate the permanent magnets from the motor.

Permanent magnets may also be positioned within a rotor core, commonly referred to as an interior permanent magnet rotor. Slots are formed within the rotor, and magnets are inserted into the slots. The magnet slots must be larger than the magnets to allow the magnets to be inserted. However, the magnets must be secured within the slots to prevent movement of the magnets during operation of the machine. The performance of the machine depends on maintaining the magnets in a known position within the rotor. An adhesive may be used to secure the magnets in a fixed position relative to the rotor. However, adhesives have a limited life due to factors such as temperature, temperature cycling, and environmental conditions.

Many known electric machines produce work by generating torque, which is the product of flux, stator current and other constants. In electric motors, flux is typically produced by permanent magnets positioned on a rotor within the motor. Some known rare earth permanent magnets, such as neodymium iron boron magnets, generate greater amounts of flux than typical ferrite permanent magnets. However, the cost of rare earth magnets has drastically risen in recent years, prompting the need for low-cost permanent magnet systems that generate similar amounts of flux and provide efficiencies similar to systems using rare earth magnets.

Positioning the permanent magnet in a radially extending orientation may enhance the magnetic field and enable the use of lower cost materials to replace rare earth magnets.

Positioning the permanent magnet in a radially extended orientation may necessitate constructions of the rotor that result in reduced cross sectional strength for the rotor which may tend to be more susceptible to the negative effects of vibrations.

Brushless motors are used in a wide variety of systems operating in a wide variety of industries. As such, the brushless motors are subject to many operating conditions. In such a brushless motor, a permanent magnet rotor and the produced torque may combine to result in cogging, as well as commutation torque pulses. The cogging and the torque pulses may get transmitted to the shaft of the motor, and then onto a fan or blower assembly that is attached to the shaft. In such applications these torque pulses and the effects of cogging may result in acoustical noise that can be objectionable to an end user of the motor.

To counter such operating conditions, introduction of a resiliency between the component that is producing these torque pulses and the shaft that transmits the torque to the fan or blower, which is attached to the shaft, would be desirable. However, the resilient rotor constructions that have been designed and produced are related to such motors where the permanent magnet structure is such that magnets are mounted on the surface of the rotor. In such systems, the resilient components are attached to a central core by metal rods or clips, spot welding, or by tig welding. However, in an interior permanent magnet rotor design, where magnets are interior to the rotor and a laminated structure is used for rotor core, it is difficult to attach a resilient component to rotor core by tig welding or spot welding without increasing a length of the rotor.

The present invention is directed to alleviate at least some of these problems with the prior art.

### BRIEF DESCRIPTION OF THE INVENTION

In one aspect, an electric machine is provided. The electric machine includes a machine housing and a stator disposed at least partially within the housing. The electric machine also includes a radially embedded permanent magnet rotor disposed at least partially within the housing and an endcap. The rotor has at least one radially embedded permanent magnet that is configured to provide increased flux to reduce motor efficiency loss. The endcap is operably connected to a distal portion of the rotor.

In another aspect, the rotor of the electric machine has a portion thereof for interfering with the radially outward movement of the at least one radially embedded permanent magnet.

In another aspect, the electric machine further includes a resilient member configured for damping vibrations.

In another aspect, the resilient member of the electric machine includes an inner portion, an outer portion, and an intermediatary portion positioned at least partially between the inner portion and the outer portion. The intermediatary portion at least partially includes a resilient material.

In another aspect, the inner portion of the resilient member of the electric machine deflects when subjected to a radial load.

In another aspect, the rotor of the electric machine includes a central portion and a plurality of spokes extending outwardly from the central portion.

In another aspect, at least one of the plurality of spokes of the rotor of the electric machine defines a first feature and the endcap of the electric machine defines a second feature.

In another aspect, first feature of the rotor of the electric machine and the second feature of the rotor of the electric machine cooperate with each other to connect the endcap to the rotor

In another aspect, first feature of the rotor of the electric machine includes an internal wall defining an aperture and the second feature of the rotor of the electric machine includes a protrusion extending from the endcap.

In another aspect, the protrusion includes one of a pin, a post, and a threaded fastener.

In another aspect, the protrusion is integral with the endcap.

In another aspect, the protrusion has an interference fit with the aperture.

In another aspect, the protrusion has a radially extending rib.

In another aspect, the rib is configured to at least one of compress or deform when positioned in the aperture.

In another aspect, at least one radially embedded permanent magnet of the rotor of the electric machine is positioned at least partially between two of the plurality of spokes of the rotor of the electric machine.

In another aspect, at least one radially embedded permanent magnet of the rotor of the electric machine defines a first part and the endcap defines a second part. The first part and the second part cooperate with each other to limit the movement of the at least one radially embedded permanent magnet relative to the endcap

In another aspect, at least one radially embedded permanent magnet of the rotor of the electric machine defines a first part and the endcap defines a second part. The first part and the second part cooperate with each other to limit the movement of the at least one radially embedded permanent magnet relative to the endcap.

In another aspect, at least one radially embedded permanent magnet of the rotor of the electric machine defines a first part and the endcap defines a second part. The first part and the second part cooperate with each other to limit the movement of the at least one radially embedded permanent magnet relative to the endcap.

In another aspect, at least one radially embedded permanent magnet of the rotor of the electric machine defines a proximate surface thereof proximate the central portion of the rotor and the proximate surface defines the first part.

In another aspect, the second part includes a member extending from the endcap.

In another aspect, the member comprises one of a pin, a post, a wedge and a threaded fastener.

In another aspect, the member is integral with the endcap.

In another aspect, the member has an inclined surface that increases the advances the member toward the proximate surface of the magnet as the endcap is advanced toward the rotor.

In another aspect, the at least one permanent magnet is a ferrite permanent magnet.

In another aspect, the electric motor further includes a second endcap. The second endcap is operably connected to the rotor and positioned opposed to the first endcap.

In another aspect, the at least one permanent magnet is fabricated from a magnetic material with remnance higher than 0.4 T, wherein the at least one permanent magnet is configured to provide increased flux to reduce motor efficiency loss compared to a copper winding.

In another aspect, the at least one permanent magnet is integral with the endcap.

In another aspect, the winding of the stator includes an aluminum winding.

In another aspect, an endcap for an electric machine is provided. The electric machine has a stator and a rotor including a permanent magnet. The endcap includes a feature cooperating with the rotor to secure the endcap to the rotor and a member cooperating with the magnet to limit the movement of the magnet relative to the rotor.

In yet another aspect, a method of manufacturing an electric machine is provided. The method includes the steps of providing a machine housing and disposing a stator at least partially within the housing. The stator includes a plurality of teeth. The method further includes the steps of winding a number of turns around at least one tooth of the plurality of teeth and disposing a rotor at least partially within the housing. The rotor has at least one permanent magnet and is configured to rotate with respect to the stator. The method further includes the step of disposing an endcap at a distal portion of the rotor.

### BRIEF DESCRIPTION OF THE DRAWINGS

FIG. 1 is a perspective view of a rotor subassembly for use in rotor assembly of the present invention;

FIG. 2 is a perspective view of the rotor assembly of the present invention including the rotor subassembly of FIG. 1;

FIG. 3 is a perspective view of an end cap for use with the rotor subassembly of FIG. 1 to be used to form the rotor assembly of FIG. 2;

FIG. 3A is a partial cross sectional view of the rotor assembly of FIG. 2 along the line 3A-3A in the direction of the arrows showing the interaction of the magnet, the rotor and the tabs of the end cap;

FIG. 3B is a partial cross sectional view of the rotor assembly of FIG. 2 along the line 3B-3B in the direction of the arrows showing the interaction of the rotor apertures and the pins of the end cap;

FIG. 3C is a enlarged partial perspective view of the end cap of FIG. 3, showing the pins and the tabs in greater detail;

FIG. 3D is a enlarged partial perspective view of an alternate embodiment of a rotor assembly of the present invention having a alternate design for the pins of the end cap;

FIG. 3E is a enlarged partial perspective view of an alternate embodiment of a rotor assembly of the present invention having a alternate design for the tabs of the end cap;

FIG. 4 is a perspective view the rotor assembly of FIG. 3 assembled onto a shaft and having the resilient support of the present invention;

FIG. 5 is a plan view, partially in cross section, of an optional resilient end support for the rotor assembly of FIG. 3;

FIG. 6 is a plan view of an end cap according to another aspect of the present invention;

FIG. 7 is an end view, partially in cross section, of the endcap of FIG. 6;

FIG. 8 is a plan view of another end cap according to another aspect of the present invention; and

FIG. 9 is a flow chart of an exemplary method for assembling an electric motor according to another aspect of the present invention.

### DETAILED DESCRIPTION OF THE INVENTION

Due to increased costs of rare earth magnets and copper used for windings, lower cost alternative materials are desirable in the design and manufacture of electric motors. The methods, systems, and apparatus described herein facilitate the utilization of lower cost alternative materials within an electric machine. This disclosure provides designs and methods using material alternatives to rare earth magnets while reducing or recapturing the efficiency losses associated with those alternative materials and reducing or eliminating an increase of the length of the motor. This disclosure further provides designs and methods to reduce the vibration caused by torque by providing resilient rotor constructions.

Technical effects of the methods, systems, and apparatus described herein include at least one of improved performance and quality and reduced labor costs.

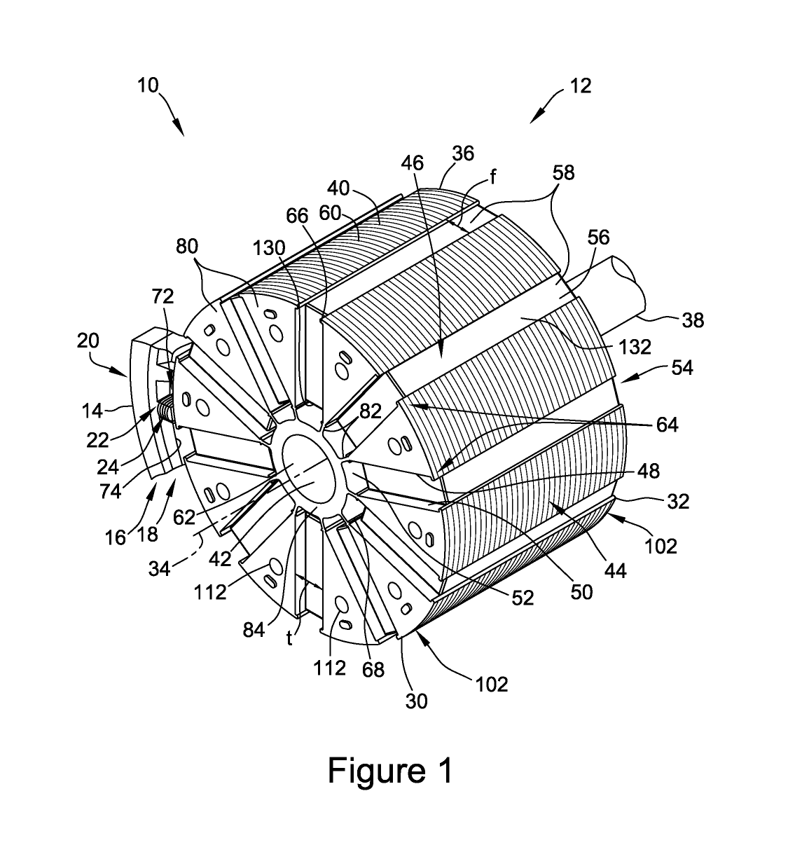

FIG. 1 is a perspective view of a rotatable assembly 12 for use in an electric motor 10 according to an embodiment of the present invention. The electric machine 10 may also include a machine assembly housing 14 and a stationary assembly 16. The machine assembly housing defines an interior 18 and an exterior 20 of machine 10 and is configured to at least partially enclose and protect stationary assembly and rotatable assembly 12.

Stationary assembly 16 typically includes a stator core 26, which includes a plurality of stator teeth or projections 22. End caps (not shown) are positioned over opposed end teeth of the plurality of stator teeth 22. Wire 28 is wound around stator teeth 22 and the end caps to form each of a plurality of windings 24. In an exemplary embodiment, stationary assembly is a three phase salient pole stator assembly. Stator core is formed from a stack of laminations made of a highly magnetically permeable material, and windings are wound on stator core in a manner known to those of ordinary skill in the art. Laminations are stacked such that stator core reaches a predefined length. In the exemplary embodiment, the plurality of laminations that form the stator core may be either interlocked or loose laminations. In an alternative embodiment, stator core is a solid core. For example, stator core may be formed from a soft magnetic composite (SMC) material, a soft magnetic alloy (SMA) material, and/or a powdered ferrite material using a sintering process. In another alternate embodiment, the windings are wound around a plurality of spools (not shown), each of which is removably fitted to one of the stator teeth.

As shown in the embodiment of FIG. 1, rotatable assembly 12 includes a permanent magnet rotor core or rotor 36 and a shaft 38 and is configured to rotate around an axis of rotation 34. In the exemplary embodiment, rotor core 36 is formed from a stack of laminations made of a magnetically permeable material and is substantially received in a central bore of stator core. While FIG. 1 is an illustration of a three phase electric motor, the methods and apparatus described herein may be included within machines having any number of phases, including single phase and multiple phase electric machines.

In the exemplary embodiment, electric machine 10 is coupled to a fan (not shown) for moving air through an air handling system, for blowing air over cooling coils, and/or for driving a compressor within an air conditioning/refrigeration system. More specifically, machine 10 may be used in air moving applications used in the heating, ventilation, and air conditioning (HVAC) industry, for example, in residential applications using ⅓ horsepower (hp) to 1 hp motors or greater and/or in commercial and industrial applications and hermetic compressor motors used in air conditioning applications using higher horsepower motors, for example, but not limited to using ⅓ hp to 7.5 hp motor or greater. Although described herein in the context of an air handling system, electric machine 10 may engage any suitable work component and be configured to drive such a work component. Alternatively, electric machine 10 may be coupled to a power conversion component, for example, an engine, a wind turbine rotor, and/or any other component configured to rotate rotatable assembly 12 to generate electricity using electric machine 10.

Continuing to refer to FIG. 1, the rotatable assembly 12, also referred to as a radially embedded permanent magnet rotor, includes the rotor core 36 and the shaft 38. Examples of motors that may include the radially embedded permanent magnet rotors include, but are not limited to, electronically commutated motors (ECM's). ECM's may include, but are not limited to, brushless direct current (BLDC) motors, brushless alternating current (BLAC) motors, and variable reluctance motors. Furthermore, rotatable assembly 12 is driven by an electronic control (not shown), for example, a sinusoidal or trapezoidal electronic control.

Rotor core 36 is substantially cylindrical and includes an outer edge 40 and a shaft central opening or inner edge 42 having a diameter corresponding to the diameter of shaft 38. Rotor core 36 and shaft 38 are concentric and are configured to rotate about axis of rotation 34. In the exemplary embodiment, rotor core 36 includes a plurality of laminations 44 that are either interlocked or loose. For example, laminations 44 are fabricated from multiple punched layers of stamped metal such as steel. In an alternative embodiment, rotor core 36 is a solid core. For example, rotor core 36 may be fabricated using a sintering process from a soft magnetic composite (SMC) material, a soft magnetic alloy (SMA) material, and/or a powdered ferrite material.

In the exemplary embodiment, rotor core 36 includes a plurality of radial apertures 46. For example, a first wall 48, a second wall 50 and a third wall 52 define a first radial aperture 54 of the plurality of radial apertures 46. Each radial aperture 46 includes a depth d and thickness t and extends axially through rotor core 36 from first end 30 (shown in FIG. 1) to second end 32 (also shown in FIG. 1). Each radial aperture 46 is configured to receive one or more permanent magnets 56 such that each magnet 56 is radially embedded in rotor core 36 and extends at least partially from rotor first end 30 to rotor second end 32. In the exemplary embodiment, permanent magnets 56 are hard ferrite magnets magnetized in a direction tangent to axis of rotation 34. However, magnet 56 may be fabricated from any suitable material that enables motor 10 to function as described herein, for example, bonded neodymium, sintered neodymium, and/or samarium cobalt.

In the exemplary embodiment, rotor core 36 includes a plurality of rotor poles 58, each having an outer wall 60 along rotor outer edge 40 and an inner wall 62 (shown in FIG. 1). In the exemplary embodiment, the number of radial apertures 46 is equal to the number of rotor poles 58, and one magnet 56 is positioned within each radial aperture 46 between a pair of rotor poles 58. Although illustrated as including ten rotor poles 58, rotor core 36 may have any number of poles that allows motor 10 to function as described herein, for example, six, eight or twelve poles.

In the exemplary embodiment, the design of radially embedded permanent magnet rotor core 36 utilizes lower-cost magnets, yet achieves the power densities and high efficiency of machines using higher-cost magnets, such as neodymium magnets. In the exemplary embodiment, increased efficiency and power density of motor 10 is obtained by increasing the flux produced by rotor core 36. Increased flux generation is facilitated by magnets 56 positioned in radial apertures 46 at depth d, between a minimum magnet depth and a maximum magnet depth. The minimum magnet depth is defined by the equation:

$${D}_{m i n} = \frac{( π * R )}{n} ,$$

wherein Dₘᵢₙ represents the minimum depth variable, R represents the rotor radius, and n represents the number of rotor poles. The maximum magnet depth is defined by the equation:

$${D}_{ma x} = R - \frac{0.5 t}{tan ( \frac{180}{n} )} ,$$

wherein Dₘₐₓ represents the maximum depth variable, R represents the rotor radius, t represents the magnet thickness in the direction of magnetization, and n represents the number of rotor poles. In the exemplary embodiment, rotor core 36 facilitates increased flux production resulting in optimum efficiency and power density when magnets 56 extend into radial aperture at a depth between Dₘᵢₙ and Dₘₐₓ.

Continuing to refer to FIG. 1, the radial apertures 46 may, as shown, be generally rectangular. Alternatively, radial apertures 46 may have any suitable shape corresponding to the shape of the permanent magnets that enables electric motor to function as described herein. For example, radial apertures 46 may be tapered, as described in more detail below.

In the exemplary embodiment of FIG. 1, radial aperture 46 includes one or more permanent magnet retention members or tabs 66. For example, a first pair of tabs 66 is located proximate pole outer wall 60 along rotor outer edge 40 and extends into radial aperture 46 from first and second walls 48 and 50. Each tab 66 of the first pair of tabs 66 is configured to facilitate retention of magnet 56 within radial aperture 46 by substantially preventing movement of magnet 56 in a radial direction towards outer edge 40. Further, a second pair of tabs 68 is located along pole inner wall 62 and extends into radial aperture 46 from first and second walls 48 and 50. Each tab 66 of the second pair of tabs 68 is configured to facilitate retention of magnet 56 within radial aperture 46 by substantially preventing movement of magnet 56 in a radial direction towards shaft 38. Alternatively, rotor core 36 may have any number and location of tabs 66 that enable rotor core 36 to function as described herein.

Alternatively, it should be appreciated that the radial apertures and magnet may be matingly generally tapered. First and second walls of the radial aperture may converge as they extend from rotor inner wall 62 to rotor outer wall 60 and are configured to engage the tapered walls of magnet to facilitate retention of magnet within radial aperture by substantially preventing movement of magnet in a radial direction towards rotor outer edge. Furthermore, each tapered radial aperture may include a pair of protrusions located along pole inner wall 62 to facilitate retention of magnet within radial aperture by substantially preventing movement of magnet in a radial direction.

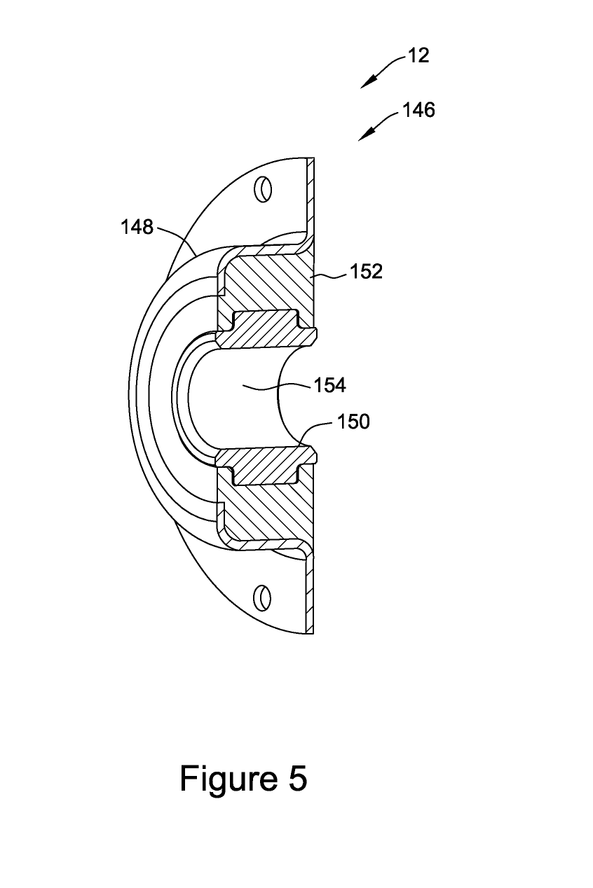

As shown in FIG. 1, the rotor core 36 is positioned relative to stationary assembly 16, and rotor outer edge 40 and an inner edge 74 of stationary assembly 16 define a small air gap 72. Air gap 72 allows for relatively free rotation of rotor core 36 within stationary assembly 16. Radially embedded magnets 56 of rotor core 36 are configured to facilitate increased flux to air gap 72, resulting in increased motor torque generation. The radial orientation of radially embedded magnets 56 results in the magnet flux only crossing the magnet once, as opposed to the flux produced by surface-mounted magnets, which must cross the magnets twice. Crossing magnet 56 only once significantly reduces the path of the flux through material of low permeability (i.e. air and magnet 56), resulting in increased flux delivery and torque. Increased flux delivery and torque also result from radial magnets 56 of the same polarity positioned on opposite edges 48 and 50 of each rotor pole 58, which focuses flux toward rotor outer edge 40. However, any magnetic support structure above or below magnet 56 in a radial direction provides a path for flux to flow without crossing air gap 72, resulting in torque losses. In the exemplary embodiment of FIG. 5, only a small or limited amount of magnetic material (i.e. tabs 66) is positioned above or below magnet 56. Alternatively, rotor core 36 does not include any magnetic material immediately above or below magnet 56 such that no magnetic material is positioned between permanent magnet 56 and rotor outer edge 40.

In the exemplary embodiment, rotor poles 58 are spaced from each other a distance f to reduce flux loss through magnetic support structure (e.g. rotor poles 58). In the exemplary embodiment, distance f is greater than or equal to five times the length of air gap 72 (the gap between rotor outer edge 40 and stator inner edge 74), facilitating high flux generation. Alternatively, distance f is greater than or equal to three times the length of air gap 72. Alternatively still, distance f is greater than or equal to ten times the length of air gap 72. In the exemplary embodiment, distance f is maintained between tabs 66. Alternatively, distance f is maintained between radial aperture walls 48 and 50 if no tabs 66 are present, or between tab 66 and wall 48 or 50 if tab 66 is present on only one of walls 48 and 50.

As shown in FIG. 1, rotor core 36 may include a plurality of laminations 44 as mentioned herein, and, for simplicity, each lamination may be similar or identical and include a plurality of pie shaped portions 80 extending by spoke portions 82 from a central tubular shape hub portion 84.

Alternatively, the rotor core may include a first half-core, a second half-core, a center lamination, and first and second end laminations. The half-cores each include a plurality of independent rotor poles positioned radially about a sleeve. A plurality of radial apertures are defined between rotor poles and are configured to receive one or more permanent magnets. Each rotor pole is held in spaced relation to sleeve by at least one of center lamination and end laminations. In this exemplary embodiment, laminations also referred to as shorting laminations, are structurally similar, and each includes a plurality of connected rotor poles positioned radially about a central hub. Rotor poles each include an outer edge and an inner edge. Adjacent pairs of rotor poles are connected at inner edges by a bridge, which is connected to central hub.

In this exemplary embodiment, the center lamination is positioned between half-cores, and end laminations are positioned on opposite ends of rotor core. In this exemplary embodiment, half-cores are solid cores. Alternatively, half-cores are formed as a whole core and/or are fabricated from a plurality of lamination layers. Although rotor core is described with a single center lamination and two end laminations, rotor core may have any number of center and end laminations that enables motor to function as described herein. Connected rotor poles support rotor poles at a distance from sleeve to prevent flux losses in half-cores, since little or no magnetic material is located above or below magnets positioned therein. A portion of flux generated by rotor core is lost, however, due at least in part to connected rotor poles of laminations. In order to minimize flux losses, in the exemplary embodiment, the sum of the thicknesses of laminations having connected rotor poles is less than or equal to 12% of the total length of rotor core. Alternatively, the sum of the thicknesses of laminations having connected rotor poles is less than or equal to 2% of the total length of rotor core. Alternatively still, the sum of the thicknesses of laminations having connected rotor poles is less than or equal to 1% of the total length of rotor core.

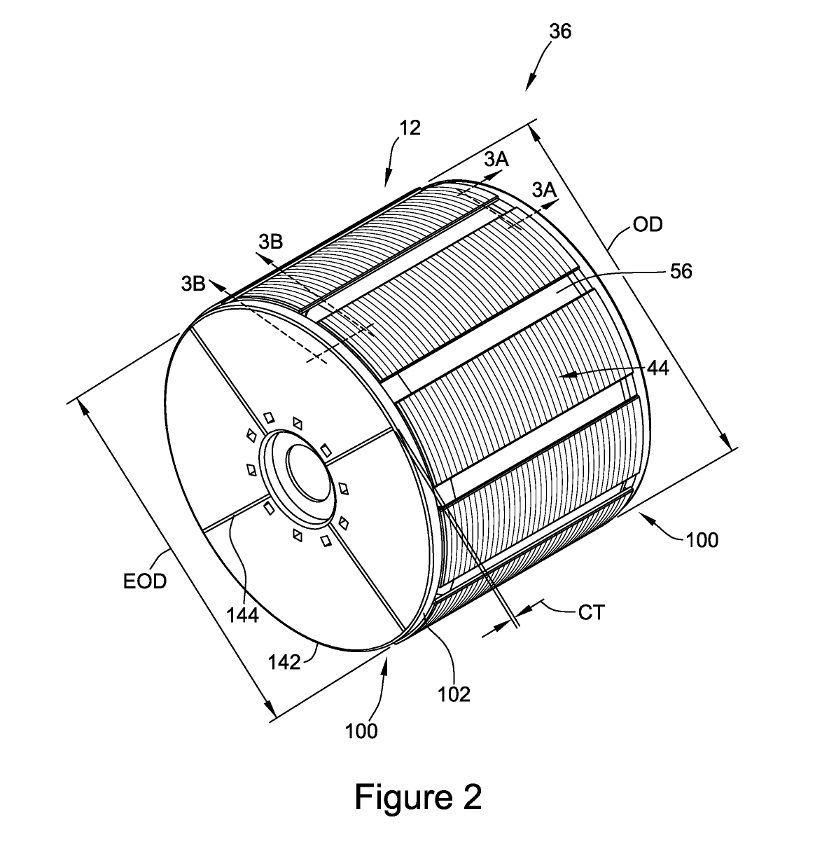

Referring now to FIG. 2 and according to an embodiment of the present invention, endcaps 100 are shown in position on opposed ends 102 of the rotor core 36. As shown, the endcaps 100 are operably connected to the rotor core 36. The endcaps may be used to assist in the securing of the components that form the rotor core 36 together and to improve the rigidity of the rotor core 36.

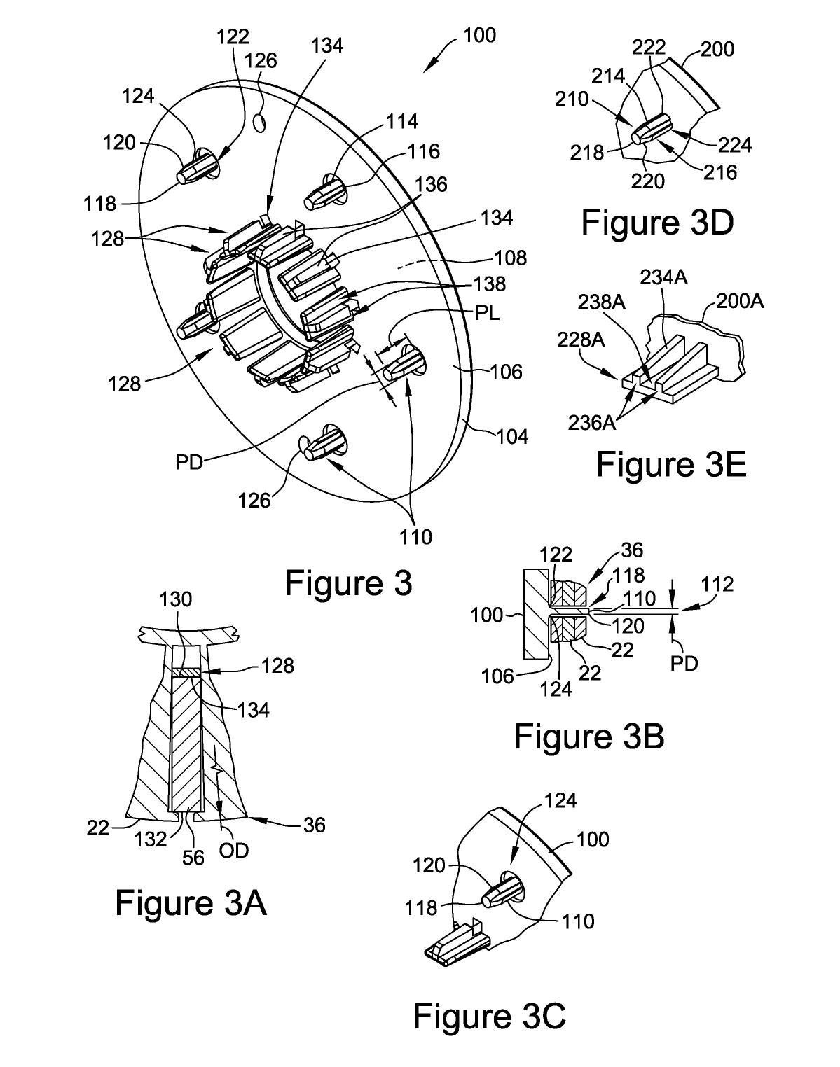

Referring now to FIG. 3, one of the endcaps 100 is shown in greater detail. The endcap 100 may have any suitable size and shape and for simplicity and as shown, the endcap 100 may have a generally cylindrical shape. For example, the endcap 100 may have an outside diameter EOD (see FIG. 3) defined by outer periphery 104 of the endcap 100 and the outside diameter EOD may be similar to outside diameter OD (see FIG. 2) of rotor core 36.

The endcap 100 may have opposed inner face 106 and outer face 108. The opposed faces 106 and 108 may be parallel and spaced apart defining an end cap thickness CT. The thickness CT is selected to provide sufficient strength and rigidity to the endcap 100. As shown in FIG. 2, the inner face 106 of endcaps 100 may mate against opposed ends 102 (see FIG. 2) of rotor core 36.

Referring now to FIG. 3 and FIG. 3B, the endcap 100 may include a rotor engaging feature 110 for engaging rotor core 36. As shown in FIG. 3B, the rotor engaging feature may be in the form of a protrusion 110 extending outwardly in a normal direction from inner face 106 of endcap 100. The protrusion 110 may have any suitable shape and preferably has a shape that cooperates with rotor endcap engaging feature 112 on rotor core 36 (see FIG. 1).

As shown in FIG. 3, FIG. 3B and FIG. 3C, the protrusion 110 may be in the form a cylindrical post 110. The post 110 may define a post diameter PD and post length PL. The post 110 may include one or more lands 114 which define one or more grooves 116 spaced therebetween. The lands 114 and grooves 116 may extend in a longitudinal direction along the post 110. The lands 114 of the post 110 may be configured to be conformable to fit matingly with the rotor endcap engaging feature 112 on rotor core 36. The lands 114 may be elastically or deformably conformable.

While the endcap 100 may include a solitary post 110, it should be appreciated and as shown in FIG. 3, the endcap 100 may include a plurality of posts 110. Each of the posts 110 may be identical or some may be different. The posts 110 may be equally spaced apart or may be spaced apart in any fashion.

Continuing to refer to FIG. 3, FIG. 3B and FIG. 3C, the post 110 may be narrowed at tip 118 of the post 110 to assist assembly onto the rotor core 36. For example the post may be stepped, have a radius or, as shown, have a chamfer 120 at the tip 118. To add durability and strength to the posts and to assist manufacturing base 122 of post 110, the endcap 110 adjacent the post 110 at the base 122 may be have a recess 124. The recess may serve to provide for a transition from the face of end cap 110 to the post 100 to assure that sharp corners are avoided and that there is no interference between the endcap 110 and the laminations 44 of rotor core 36 (see FIG. 1).

Referring again to FIG. 3B and FIG. 2, the rotor endcap engaging feature 112 on rotor core 36 may have any suitable configuration to cooperate with the rotor engaging feature 110 of endcap 100. For example and as shown in FIG. 3B and FIG. 2, the rotor endcap engaging feature 112 may be in the form of an aperture 112, for example, a cylindrical shaped opening formed in at least some of the laminations 44 that form the rotor core 36.

Referring again to FIG. 3, the rotor engaging feature 110 of endcap 100 may be in the form of an aperture or opening 126 formed in the endcap 100. A single or a plurality of openings 126 may be used. The rotor engaging feature 110 of endcap 100 may include either posts 110 or openings 126, or as shown in FIG. 3, may include both posts 110 and openings 126. The openings 126 may be positioned in alignment with the apertures 112 in the laminations 44 of the rotor core 36. Fasteners (not shown), in the form of rivets or threaded fasteners may be matingly inserted into the openings 126 and the apertures 112, The fasteners may extend from one endcap 100 to the opposed endcap 100, securing the endcaps 100 to the laminations 44 that form the rotor core 36 to each other. The fasteners further improve the rigidity of the rotor core 36.

Referring to FIG. 3, FIG. 3A and FIG. 3C, the endcap 100 may include a magnet engaging feature 128 for cooperation with the magnets 56 positioned in rotor core 36. The magnet engaging feature 128 may serve to limit the movement of the magnets 56 relative to the rotor core 36.

As shown in FIG. 1 features, in the form of, for example, outer tabs 66 and inner tabs 68, may be used to limit the motion of the magnets 56 within the pockets 46 formed in rotor core 36. Even with such limiting motion features 66 and 68, manufacturing tolerances and need for assembly clearances may permit the magnets 56 to move within the pockets 46, particularly at high rotational speeds of the rotor core 36. Such movement of the magnets may contribute to vibration and/or noise. The magnet engaging feature 128 is intended to serve to limit the movement of the magnets 56 relative to the rotor core 36 and to reduce such vibration and/or noise.

As shown in FIG. 3, FIG. 3A and FIG. 3C, the magnet engaging feature 128 may be in the form of a protrusion 128. Note that there may be, as shown, a solitary protrusion 128 defining the magnet engaging feature 128 or a plurality of protrusions. The protrusions 128 cooperates with the magnets 56 and, as such, the protrusions 128 may have a one to one relationship with the magnets 56 and may, like the magnets 56, be uniformly positioned in the rotor core 36. As shown in FIG. 2, the protrusions 128 may, when the endcaps 100 are positioned on rotor core 36, be matingly fitted into the pockets 46 of the rotor core 36.

While, as shown in FIG. 3, FIG. 3A and FIG. 3C, the protrusions 128 engage inner face 130 of the magnets 56, it should be appreciated that the protrusions 128 may be positioned relative to the magnets such that the protrusions 128 engage any other portion of the magnets, for example the outer face 132 of the magnets 56.

The protrusions 128 may have any suitable shape and may, since the endcaps 100 are assembled onto the opposed ends 102 of the rotor core 36, extend normally from inner face 106 of endcap 100. The protrusions 128 may have a simple shape such as rectangular or cylindrical shape. As shown the protrusions have a generally rectangular shape. While the protrusions may be rectangular, as shown the protrusions 128 may include an inclined face 134 for engagement with inner face 130 of the magnets 56.

The inclined face 134 of the protrusion 128 serves to urge the magnet 56 toward the outer tab 68 of rotor core 36 as the endcap 100 is assembled onto the rotor core 36. Preferably the endcap 100 is made of a resilient material and is integral such that the protrusion 128 keeps an outwardly force on the magnet, keeping it securely against the outer tabs 68 of rotor core 36, reducing vibration and noise.

While the inclined face 134 of the protrusion 128 may be planar, as shown in FIG. 3, the inclined face 134 may have a centrally located raised portion 136 centrally positioned between relieved portions 138. The centrally located raised portion 136 guide the magnet 56 outwardly and the relieved portions 138 provides added resiliency to the protrusion 128.

While the rotor engaging features 110 in the form of conformable posts 110 may be sufficient to provide the rotor core 36 with sufficient rigidity with or without the fasteners positioned in the openings 126 and in the apertures 112 and while the magnet engaging features 128 in the form of protrusions 128 may be sufficient to rigidly secure the magnets 56, it should be appreciated that to obtain further rigidity for the rotor core 36, including improved rigidity for the magnets 56, the rotor core 36 may further include a material, for example a fluid or otherwise conformable material that may dry, form, harden or cure around the posts 110 and/or around the protrusions 128 and other portions of the rotor core 36 to add further rigidity to the rotor core 36. Such a fluid or conformable material may be a sealant, an adhesive, a coating, a varnish, a paint or a polymer in liquid or solid form.

Referring now to FIG. 2, the endcaps 100 are shown positioned on opposed ends 102 of rotor core 36. The outer face 108 of endcap 100 may include an outer circular rib 142 and axial ribs 144 to provide rigidity for the endcap 100.

The Endcap 100 may be made of any suitable durable material. For example the endcap 100 may be made of a non-electrically conductive, non-magnetically conductive material. For example, the endcap 100 may be made of a polymer. If made of a polymer, the endcap 100 may be molded into an integral piece.

Referring now to FIG. 3D and according to another embodiment of the present invention, endcap 200 is shown. Endcap 200 is similar to endcap 100 except endcap 200 includes a protrusion, pin or post 210 different than post 110 of the endcap 100 of FIG. 3.

As shown in FIG. 3D, the protrusion 210 may be in the form a cylindrical post 110. The post 210 may include one or more lands 214 which define one or more grooves 216 spaced therebetween. The lands 214 and grooves 216 may extend in a longitudinal direction along the post 210. The lands 214 of the post 210 may be configured to be conformable to fit matingly with the rotor endcap engaging feature 112 on rotor core 36. The lands 214 may be elastically or deformably conformable.

While the endcap 200 may include a solitary post 210, it should be appreciated and as shown in FIG. 3, the endcap 200 may include a plurality of posts 210. Each of the posts 210 may be identical or some may be different. The posts 210 may be equally spaced apart or may be spaced apart in any fashion.

The post 210 may be narrowed at tip 218 of the post 210 to assist assembly onto the rotor core 36. For example the post may be stepped, have a radius or, as shown, have a chamfer 220 at the tip 218. To add durability and strength to the posts and to assist manufacturing base 222 of post 210, the post at the base 222 may have a chamfer or as shown, a radius 224.

Referring now to FIG. 3E and according to an embodiment of the present invention, endcap 200A is shown. Endcap 200A is similar to endcap 100 except endcap 200A includes a magnet engaging feature 228A different than magnet engaging feature 128 of the endcap 100 of FIG. 3.

Referring to FIG. 3E, the endcap 200A may include a magnet engaging feature 228A for cooperation with the magnets 56 positioned in rotor core 36. The magnet engaging feature 228A may serve to limit the movement of the magnets 56 relative to the rotor core 36.

As shown in FIG. 3E, the magnet engaging feature 228A may be in the form of a protrusion 228A. Note that there may be a solitary protrusion 228A or a plurality of protrusions 228A. The protrusions 228A cooperate with the magnets 56 and, as such, the protrusions 228A may have a one to one relationship with the magnets and may, like the magnets 56, be uniformly positioned in the rotor core 36. As shown in FIG. 2, the protrusions 228A may, when the endcaps 200A are positioned on rotor core 36, be matingly fitted into the pockets 46 of the rotor core 36.

While, as shown in FIG. 3E, the protrusions 228A engage inner face 130 of the magnets 56, it should be appreciated that the protrusions 228A may be positioned relative to the magnets such that the protrusions 228A engage any other portion of the magnets, for example the outer face 132 of the magnets 56.

The protrusions 228A may have any suitable shape and may, since the endcaps 200A are assembled onto the opposed ends 102 of the rotor core 36, extend normally from inner face of endcap 200A. The protrusions 228A may have a simple shape such as rectangular or cylindrical shape. As shown the protrusions have a generally rectangular shape. While the protrusions may be rectangular, as shown the protrusions 228A may include an inclined face 234A for engagement with inner face 130 of the magnets 56.

The inclined face 234A of the protrusion 228A serves to urge the magnet 56 toward the outer tab 68 of rotor core 36 as the endcap 200A is assembled onto the rotor core 36. Preferably the endcap 200A is made of a resilient material and is integral such that the protrusion 228A keeps a outwardly force on the magnet, keeping it securely against the outer tabs 68 of rotor core 36, reducing vibration and noise.

While the inclined face 234A of the protrusion 228A may be planar, as shown in FIG. 3E, the inclined face 234A may have spaced apart end portions 236A separated by a relieved portion 238A. The end portions 236A guide the magnet 56 outwardly and the relieved portion 238A provides added resiliency to the protrusion 228A.

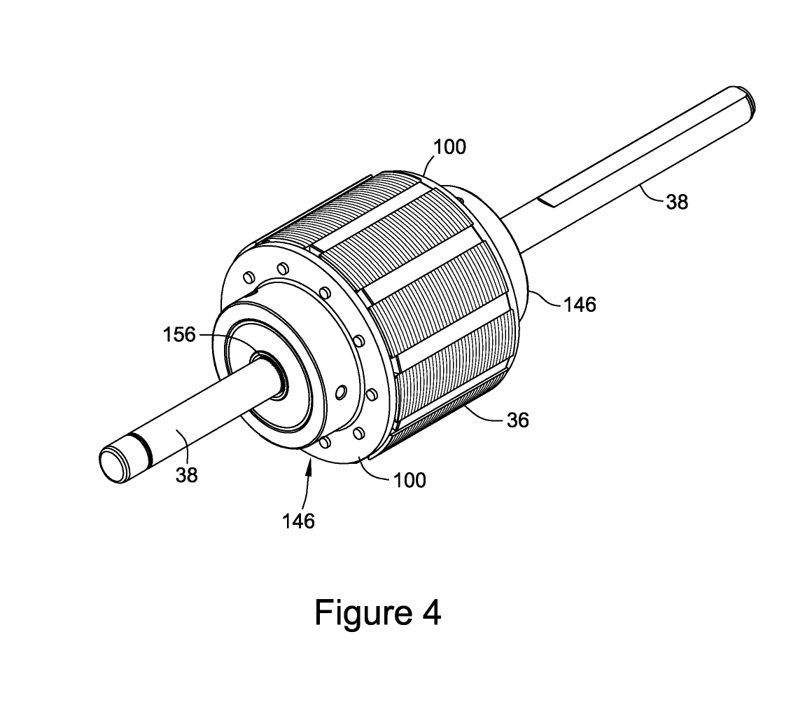

As shown in FIG. 4, the rotor assembly 12 may include a resilient structure 146 positioned between the rotor core 36 and the shaft 38. The resilient structure 146 in the rotor assembly 12 is beneficial in the suppression of vibration transmissibility from the motor.

Referring now to FIG. 5, the resilient structure of FIG. 4 is shown in greater detail. In the illustrated embodiment, the rotor assembly 12 includes the resilient structure 146 that includes an outer rigid structure 148, an inner rigid structure 150, and a resilient component 152 that is in the annular space between the inner rigid structure 150 and the outer rigid structure 148.

As shown in FIGS. 4 and 5, these three components are located proximate a endcap 100 of rotor assembly 12 such that inner rigid structure 150 engages shaft 38 and outer rigid structure 148 engages, for example, a endcap 100 that engages rotor core 36 that contains the various interior permanent magnets 56 therein. In embodiments, an interior surface 154 of inner rigid structure 150 is attached to the corresponding portion 156 of shaft 38 to provide rotation of shaft 38. In specific embodiments, interior surface 154 of inner rigid structure 150 as well as the corresponding portion 156 of shaft 38 are keyed such that rotation of rotor core 36 ensures rotation of shaft 38. It should be appreciated that the shaft 38 may be in clearance with the opening 42 formed in rotor core 36 such that vibrations between core 36 and shaft 38 are isolated from each other.

In various embodiments, the three components (outer rigid structure 148, inner rigid structure 150, and resilient component 152) are fabricated as separate components or are molded together as a single component. Fabrication includes placing inner rigid structure 150 within a bore extending through the resilient component. In various implementations, two resilient structures 146 are utilized in a motor configuration, for example, one on each end of a rotor. Alternatively, a single resilient structure 146 may be utilized proximate the axial center of rotor core 36.

In various embodiments resilient component 152 is a thermoset material or a thermoplastic material, for example rubber, or other elastomeric, low modulus material of between about 30 and about 70 MPa (MegaPascals), which is either preformed or formed in place. In one embodiment, resilient component 152 is formed in place such that it is attached to the inner rigid structure 150. Resilient structure 146 can be attached to the endcaps 100 and central rotor core 36 (laminations 44) using various mechanical devices, including, but not limited to, rivets, bolts and nuts, keyways, adhesives, and columns that are inserted, injected or cast. Alternatively, resilient structure 146 may be press fit within the rotor core 36 in a fashion similar to the seating of a bearing.

Since the resilient component 152 is quite pliable, securing the resilient component 152 to the outer rigid structure 148 and to the inner rigid structure 150 is preferred, as mechanical connections, such as interference fits and even mechanical interlock of components may not be sufficient to prevent motion between the resilient component and the outer rigid structure 148 and/or the inner rigid structure 150. Surface treatments to the outer rigid structure 148 and/or the inner rigid structure 150 may reduce such motion. Alternatively or in addition, a material such as an adhesive may be applied between the resilient component 152 and the outer rigid structure 148 and/or the inner rigid structure 150 to further reduce such motion.

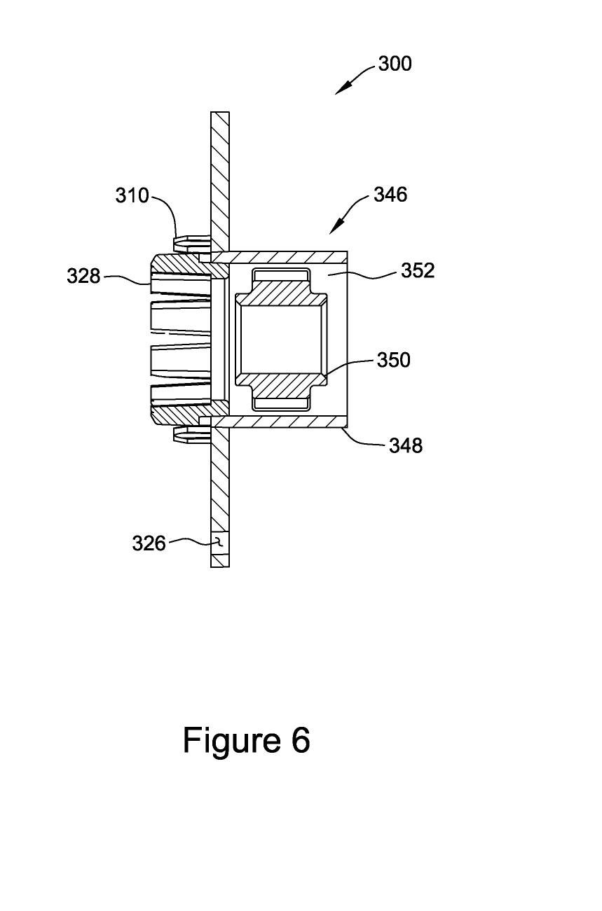

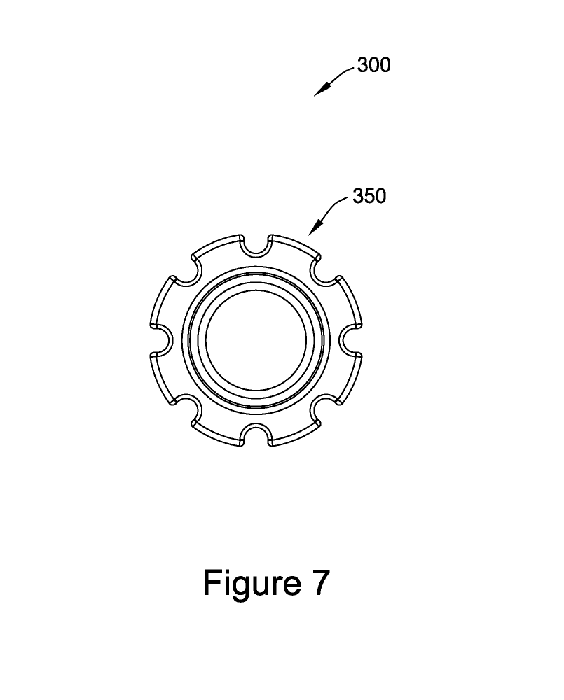

Referring now to FIGS. 6 and 7, another embodiment of an endcap for use in a rotor assembly according to an embodiment of the present invention is shown as endcap 300. Endcap 300 is similar to endcap 100 of FIGS. 2-4, except endcap 300 may include a resilient structure 346 that includes an outer rigid structure 348 that is integral with end cap housing 302.

The endcap 300, as shown in FIG. 6, includes an outer rigid structure 348 that, unlike the outer rigid structure 148 of resilient structure 146 of FIG. 4, is integral with end cap housing 302. The outer rigid structure 348 serves as a portion of a resilient structure 346 that functions similarly to the resilient structure 146 of FIG. 4. The resilient structure 346 further includes an inner rigid structure 350 and a resilient component 352. The inner rigid structure 350 may be similar or identical to inner rigid structure 150 of FIG. 5. The resilient component 352 may be similar or identical to the resilient component 152 of FIG. 5.

Similarly to the resilient component 152 of the resilient structure 146 of the motor 10 of FIGS. 1-5, the resilient component 352 is quite pliable. Securing the resilient component 352 to the outer rigid structure 348 and to the inner rigid structure 350 is preferred, as mechanical connections, such as interference fits and even mechanical interlock of components may not be sufficient to prevent motion between the resilient component and the outer rigid structure 348 and/or the inner rigid structure 350.

The endcap 300 may include one or more rotor engaging features 310 for engaging rotor core 36. The rotor engaging features 310 may be in the form of protrusions 310 similar to protrusions 110 of the endcap 100 of FIG. 3. The protrusions 310 may be in the form of posts 310 similar to posts 110 of the endcap 100 of FIG. 3. Similarly, the endcap 300 may further include openings 326 similar to openings 126 of the endcap 100 of FIG. 3.

The endcap 300 may further include one or more magnet engaging features 328 for cooperation with the magnets 56 positioned in rotor core 36. The magnet engaging feature 328 may be in the form of protrusions 328 similar to protrusions 128 of the endcap 100 of FIG. 3. The protrusions 328 may include an inclined face 334 similar to protrusions 128 of the endcap 100 of FIG. 3 for engagement with inner face 130 of the magnets 56.

The Endcap 300 may be made of any suitable durable material. For example the endcap 300 may be made of a non-electrically conductive, non-magnetically conductive material. For example, the endcap 300 may be made of a polymer. If made of a polymer, the endcap 300 may be molded into an integral piece.

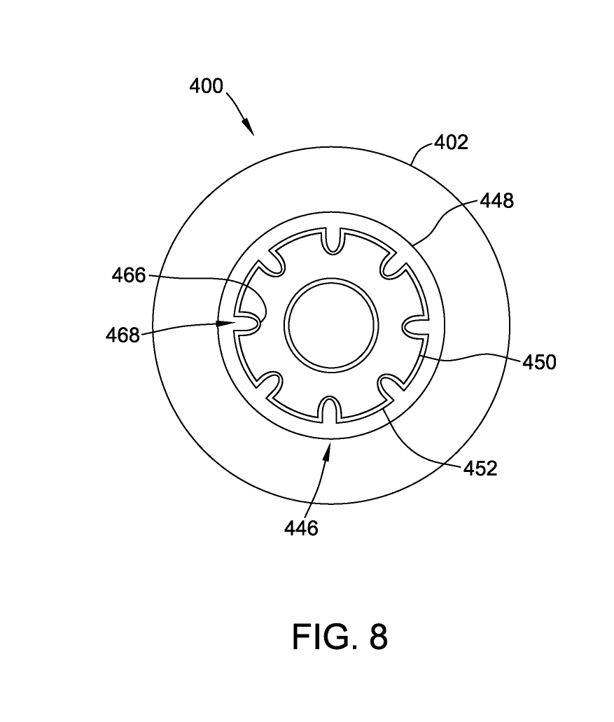

Referring now to FIG. 8, another embodiment of an endcap for use in a rotor assembly according to an embodiment of the present invention is shown as endcap 400. The endcap 400 includes an endcap housing 402. The endcap housing 402 is similar to endcap housing 302 of FIGS. 6 and 7 and may include the magnet engaging features (not shown), the openings (not shown), and the rotor engaging features (not shown) of the endcap housing 302 of FIGS. 6 and 7. Endcap 400 includes a resilient structure 446 that includes an outer rigid structure 448 that, like the outer rigid structure 348 of the resilient structure 346 of FIGS. 6 and 7, is integral with end cap housing 402. The resilient structure 446 further includes an inner rigid structure 450. The inner rigid structure 450 may be similar or identical to inner rigid structure 350 of the resilient structure 346 of FIGS. 6 and 7. The resilient structure 446 further includes an resilient component 452. The resilient component 452 may be similar or identical to resilient component 352 of the resilient structure 346 of FIGS. 6 and 7.

Similarly to the resilient component 352 of the resilient structure 346 of FIGS. 6 and 7, the resilient component 452 is quite pliable. Securing the resilient component 452 to the outer rigid structure 448 and to the inner rigid structure 450 is preferred, as mechanical connections, such as interference fits and even mechanical interlock of components may not be sufficient to prevent motion between the resilient component and the outer rigid structure 448 and/or the inner rigid structure 450.

Since the endcap housing 402 is preferably molded from a polymer material, materials that may serve to provide adherence of the resilient component 152 to the outer rigid structure 148 and/or to the inner rigid structure 150, when made of a metal, such as in the outer rigid structure 148 and/or the inner rigid structure 150 of the resilient structure 146 of FIGS. 1-5, may not serve to adhere the resilient component 452 to the outer rigid structure 448 and/or to the inner rigid structure 450 of the resilient structure 446 of FIG. 8.

While, as stated earlier, mechanical interference between the resilient component and a rigid component may not be sufficient, providing mechanical interference between two rigid components, the outer rigid structure 448 and the inner rigid structure 450 may be sufficient. As shown in FIG. 8, the outer rigid structure 448, as shown, includes protrusions 466 that cooperate with pockets 468 formed in the inner rigid structure 450. The resilient component 452 is positioned between the outer rigid structure 448 and the inner rigid structure 450 to provide the needed resiliency.

The above described embodiments are associated with a resilient rotor construction for an interior permanent magnet rotor used, for example, in a brushless motor. The resilient rotor assembly helps to suppress the cogging and commutation torque pulses known to occur in a permanent magnet rotor which does not incorporate a resilient rotor assembly.

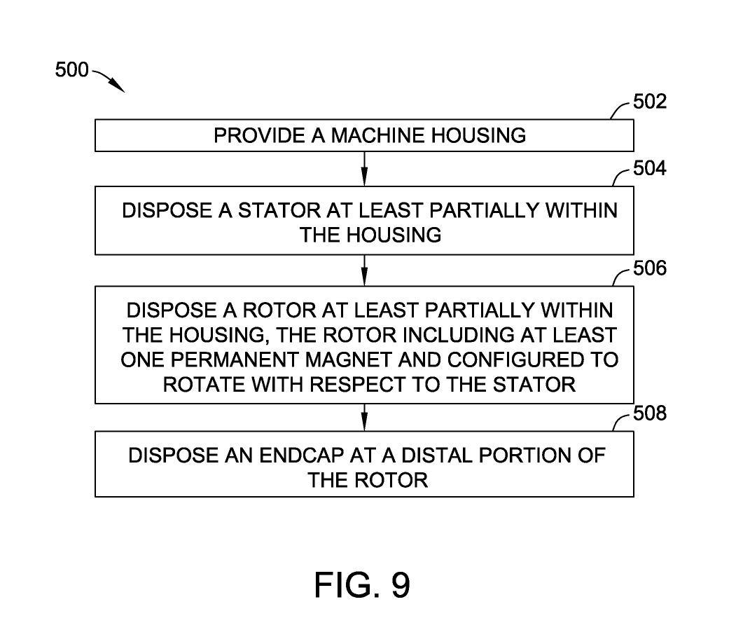

Referring now to FIG. 9, a flow chart of an exemplary method 500 for manufacturing an electric machine 10 (see FIG. 1). The method 500 includes the step 502 of the step of providing a machine housing 14 (see FIG. 1). The method 500 further includes the step 504 of disposing a stator 16 (see FIG. 1) at least partially within the housing 14 (see FIG. 1). The method 500 further includes the step 506 of disposing a rotor 12 (see FIG. 1) at least partially within the housing 14 (see FIG. 1). The rotor 12 (see FIG. 1) has at least one permanent magnet 56 (see FIG. 1) and is configured to rotate with respect to the stator. The method 500 further includes the step 508 of disposing an endcap 100 (see FIG. 2) at a distal portion of the rotor 12 (see FIG. 1).

The methods, systems, and apparatus described herein facilitate efficient and economical assembly of an electric motor. Exemplary embodiments of methods, systems, and apparatus are described and/or illustrated herein in detail. The methods, systems, and apparatus are not limited to the specific embodiments described herein, but rather, components of each apparatus and system, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “the” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Described herein are exemplary methods, systems and apparatus utilizing lower cost materials in a permanent magnet motor that reduces or eliminates the efficiency loss caused by the lower cost material. Furthermore, the exemplary methods system and apparatus achieve increased efficiency while reducing or eliminating an increase of the length of the motor. The methods, system and apparatus described herein may be used in any suitable application. However, they are particularly suited for HVAC and pump applications.

Exemplary embodiments of the electric motor assembly are described above in detail. The electric motor and its components are not limited to the specific embodiments described herein, but rather, components of the systems may be utilized independently and separately from other components described herein. For example, the components may also be used in combination with other motor systems, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electric machine comprising:
a machine housing;
a stator disposed at least partially within said housing, said stator comprising a plurality of teeth and a winding wound around at least one tooth of said plurality of teeth;
a radially embedded permanent magnet rotor disposed at least partially within said housing, said rotor comprising at least one radially embedded permanent magnet and configured to provide increased flux to reduce motor efficiency loss; and
an endcap operably connected to a distal portion of said rotor.

2. The machine of claim 1, wherein the said rotor comprises a portion thereof for interfering with the radially outward movement of said at least one radially embedded permanent magnet.

3. The machine of claim 1, wherein said endcap comprises a resilient portion configured for damping vibrations.

4. The machine of claim 3, wherein said endcap comprises:
an inner portion;
an outer portion; and
an intermediatary portion positioned at least partially between said inner portion and said outer portion, said intermediatary portion at least partially comprising a resilient material.

5. The machine of claim 1, wherein said rotor comprises a central portion and a plurality of spokes extending outwardly from the central portion.

6. The machine of claim 5:
wherein at least one of said plurality of spokes defines a first feature; and
wherein said endcap defines a second feature, said first feature and said second feature cooperating with each other to connect said endcap to said rotor.

7. The machine of claim 6:
wherein said first feature comprises an internal wall defining an aperture; and
wherein said second feature comprises a protrusion extending from the said endcap.

8. The machine of claim 7, wherein the protrusion comprises one of a pin, a post, and a threaded fastener.

9. The machine of claim 7, wherein the protrusion is integral with said endcap.

10. The machine of claim 7, wherein the protrusion has an interference fit with the aperture.

11. The machine of claim 7, wherein the protrusion has a radially extending rib.

12. The machine of claim 11, wherein the rib is configured to at least one of compress or deform when positioned in the aperture.

13. The machine of claim 5;
wherein said at least one radially embedded permanent magnet is positioned at least partially between two of said plurality of spokes.

14. The machine of claim 13:
wherein said at least one radially embedded permanent magnet defines a first part; and
wherein said endcap defines a second part, said first part and said second part cooperating with each other to limit the movement of said at least one radially embedded permanent magnet relative to said endcap.

15. The machine of claim 14:
wherein said at least one radially embedded permanent magnet defines a proximate surface thereof proximate the central portion of said rotor; and
wherein the proximate surface defines the first part.

16. The machine of claim 14, wherein the second part comprises a member extending from the said endcap.

17. The machine of claim 16, wherein the member comprises one of a pin, a post, a wedge and a threaded fastener.

18. The machine of claim 16, wherein the member is integral with said endcap.

19. The machine of claim 16, wherein the member has an inclined surface that increases the advances the member toward the proximate surface of the magnet as said endcap is advanced toward the rotor.

20. The machine of claim 1, wherein said at least one permanent magnet is a ferrite permanent magnet.

21. The machine of claim 1, further comprising a second endcap, said second endcap operably connected to said rotor and positioned opposed to said first mentioned endcap.

22. The machine of claim 1, wherein said at least one permanent magnet is fabricated from a magnetic material with remnance higher than 0.4 T, wherein said at least one permanent magnet is configured to provide increased flux to reduce motor efficiency loss compared to a copper winding.

23. The machine of claim 1, wherein said at least one permanent magnet is integral with said endcap.

24. The machine of claim 1, wherein the winding of said stator comprises an aluminum winding.

25. An endcap for an electric machine having a stator and a rotor including a permanent magnet, said endcap comprising:
a feature cooperating with the rotor to secure the endcap to the rotor; and
a member cooperating with the magnet to limit the movement of said magnet relative to the rotor.

26. A method of manufacturing an electric machine, the method comprising:
providing a machine housing;
disposing a stator at least partially within the housing, the stator comprising a plurality of teeth;
winding an winding a number of turns around at least one tooth of the plurality of teeth;
disposing a rotor at least partially within the housing, the rotor comprising at least one permanent magnet and configured to rotate with respect to the stator; and
disposing an endcap at a distal portion of said rotor.
